(19) United States
(12) Patent Application Publication
(10) Pub. No.: US 2005/0078829 A1
(43) Pub. Date: Apr. 14, 2005

(54) Trainable remote RF signal alert system and method for using same

(76) Inventors: Brad R. Knechtel, Johnsburg, IL (US); George Toth, Arlington Heights, IL (US)

Correspondence Address: Robert L. Knechtel, 1105 Moraine Drive, Woodstock, IL, 60098, US

(21) Appl. No.: 10/681,083

(22) Filed: Oct. 8, 2003

(51) Int. Cl. H04K 1/00

(52) U.S. Cl. 380/270

(57) ABSTRACT

System and method for the remote alerting of a user that his or her RF signal receiving device, e.g., cellular phone, pager, email apparatus, or other RF signal receiving device, is receiving an incoming signal. The system employs a RF detector, unique data word generator, unique data word transmitter, and unique data word receiver. The unique data word generator is notified of an incoming RF signal, creates a unique data word that is then transmitted by the unique data word transmitter to a remote unique data word receiver, the unique data word receiver verifying the unique data word and, if acceptable, emitting an alert to the user.

### I. FIELD OF INVENTION

The present invention relates to alerting systems and, more particularly, to a system that notifies a person remotely that a radio frequency (“RF”) based device is receiving a signal. The system includes an RF signal detector, RF signal transmitter, a unique data word (data alert), and RF signal receiver.

### II. BACKGROUND OF INVENTION AND PRIOR ART

Radio Frequency (“RF”) based devices are in common use throughout the world. They are used in many different settings and for a variety of uses. A non-limiting example is the cellular phone. Cellular phones are pervasive in modern society. Some experts estimate that approximately 500 million new cellular phones will be manufactured each year for the next several years. The growing number of cellular phones makes them no longer luxuries but necessities. Whether for business or personal use, mundane to emergency purposed, the cellular phone is integral to modern life.

Conventional cellular phones are packaged in a manner that allows the cellular subscriber to hold the phone comfortably, enter phone numbers or other data and read a screen that is large enough to display numbers or games. As with most items that provide great convenience and flexibility, cellular phones are no exception in having drawbacks.

While one might be expected to have a cellular phone with them at all, or most, times, having it in hand or on your body is not always a viable option: due to the size of the phone, or due to a fashion decision, a subscriber may choose to carry the phone in a purse, briefcase, coat pocket, etc. For example, those engaging in sports may need to know if a call or other message is coming in to them, but wearing a cellular phone is not practical. In business meetings, call or message notification can be important, but it is not always looked upon kindly if a cellular phone is sitting on a table, threatening to disrupt a meeting at any time. Women, in particular, often do not have pockets or appropriate clothing on to which a cellular phone can be attached and often keep them in purses where a call can be missed since the ringer cannot be heard. Other types of receivers, such as pagers and email delivery apparatus, suffer from the same problems.

Attempts have been made to overcome these issues, but they are not all without shortcomings. Conventional alert systems, such as pagers, for example, receive a signal from a central office as a result of a broadcast message covering a wide area. In addition to requiring a central office, the pager itself is bulky and, as noted above, suffers from the same general practical drawbacks as the cellular phone.

Other attempts at advancing the art of call notification have been proposed but all also have as their principle shortcoming the feature that they require a central office or broadcast signal mechanism. See, for example, U.S. Pat. No. 6,442,241 to Tsumpes, U.S. Pat. No. 6,529,500 to Pandharipanode, U.S. Pat. No. 6,529,723 to Bentley, and U.S. Pat. No. 6,532,489 to Merchant.

Attempts to get away from a central office message broadcast have been made. In this area of prior art, a device, remotely maintained, notifies a person that a cellular phone in the vicinity is ringing. These devices do not transmit a signal themselves but instead only detect the same incoming signal as a RF signal receiving device, if the signal is in the vicinity of the device. When a nearby signal “hits” the device, it emits an alert. A shortcoming of this the device is that it is unable to discern a person's particular RF signal receiving device. Instead, the device will activate if any device within its receiving range. This, of course, can be very confusing if more than one device is in the vicinity, a common occurrence. Also, the alerting device must be very close to the target RF signal receiving device to work. If too far away, a matter of feet, it will not work, or it may set off if another RF signal receiving device is nearby. An example of this prior art device is found in U.S. Pat. No. 6,263,218 B1 to Kazunori.

Accordingly, there is need for a remote, trainable RF signal alerting system that can notify a subscriber that a signal is being sent to his or her individual RF signal receiving device. Such a system would enable a user to have his or her RF signal receiving device, such as a cellular phone, located remotely from them and notify the user when an RF signal is being sent to the device when it receives a signal. The present invention meets this need.

The present invention is a system that incorporates an RF signal detector, unique data word generator, unique data word transmitter, and unique data word receiver. The RF signal detector detects the occurrence of an incoming signal. Once an incoming signal is detected, the RF signal detector notifies a unique word data generator of the signal which creates a unique data word. The unique data word is then transmitted to a unique data word receiver via a unique data word transmitter. The unique data word receiver verifies the unique data word and, if acceptable, emits an alert to the user.

A unique data word for each system ensures that each user has his or her unique alert and eliminates the possibility of false alarms. If a secured transmission is desired, various encryption techniques can be used, for example code hopping.

### III. OBJECTS AND ADVANTAGES OF THE INVENTION

It is an object of the present invention to provide a trainable remote RF signal alert system that will enable a user to have an RF signal device remotely located and be notified of an incoming signal.

It is a further object of the invention to provide a stand alone RF detector design works with a variety of RF signal producing devices, including without limitation, cellular phones.

Yet another object of the present invention is that no central office system is required.

Yet another object of the invention is to provide an alert system that comprises an RF signal detection device, unique data word generator, an RF signal transmitter, and an RF signal receiver.

The above object of the invention is enhanced by the use of a unique data word which ensures that only a user's individual RF signal alert system will activate when a signal is received by an RF signal receiving device.

A further object of the present invention is to enable the use of encryption technology for transmission when privacy and security are necessary.

Yet another object of the invention is to provide an alert system that can rely on the RF signal receiving device to which it is associated to operate as an RF signal dectector.

An advantage of the present invention is that it is not necessary for sign up or added features required by the cellular infrastructure.

Another advantage is that data word ensures that there are no false alarms in a crowded area. Additional use of data encryption enhances security in required circumstances.

Yet another advantage is that multiple receivers can be trained to a single transmitter or conversely, multiple transmitters can be trained to a single receiver.

Yet another advantage of the present invention is that with the availability of a small secure alert system, cellular phone vendors will be able to offer phones with increased capability such as larger color screens and data interfaces as the subscriber will not feel compelled to “wear” the phone. Additionally, vendors of handheld type computers can expand their product line by offering cellular communication packages in larger form factors.

### IV. BRIEF DESCRIPTION OF THE INVENTION

The above objects and advantages are provided for by the present invention. The present invention relates to RF signal alerting devices and, more particularly, to a system that notifies a person remotely that his or her device is receiving a signal. As will be appreciated by those skilled in the arts, the inventive device can be used in any RF signal receiving device, such as a cellular phone, an email device, or pager. It is important to note that while the preferred embodiment of the present invention is presented as used in a cellular phone, the system can be used with any system in which an individual needs to be notified of an incoming RF signal.

The present invention comprises an RF detector, RF transmitter, a unique data word (data alert), and RF receiver. The use of a unique data word eliminates the possibility of false alarms resulting from a large number of alert systems in a crowded area such as a stadium, shopping mall, office building etc. Data encryption enables a more secure environment.

Briefly, the RF signal detector, data word generator, and unique word transmitter are linked to an RF signal receiving device. When the RF signal receiving device receives an RF signal, it activates the RF signal detector of the alert system. The RF detector transmits a notification to data word generator that a RF signal was received by RF signal receiving device. The data word generator then creates a unique data word recognizable only by the unique data word receiver.

The data word generator relays the unique word to the unique data word transmitter. The unique data word transmitter transmits the unique data word to a remote unique data word receiver. The remote unique data word receiver in turn verifies the unique data word and, if acceptable, emits an audio, visual, or vibratory signal which alerts the RF signal receiving device user that his or her device is receiving a signal.

### V. BRIEF DESCRIPTION OF THE DRAWINGS

FIG. 1 illustrates a flowchart depicting a general overview of the inventive system in use.

FIG. 2 depicts the instance when RF signal detector is a separate detection component that is embedded into a RF receiving device along with the data word generator, and unique word transmitter.

FIG. 3 depicts the instance when the RF signal receiving device acts as the RF signal detector, thereby sending notification directly to the data word generator, which, along with unique word transmitter is embedded into the RF signal receiving device.

FIG. 4 depicts the instance when the RF signal detector, data word generator, and unique word transmitter are externally linked to the RF signal receiving device, using the RF signal receiving device power supply for its power.

FIG. 5 depicts the instance when RF signal detector, data word generator, and unique word transmitter are externally linked to RF signal receiving device and employs an external power supply for operation.

FIG. 6 depicts a flow chart illustrating a typical alert sequence in a cell phone.

### VI. DETAILED DESCRIPTION OF THE PREFERRED EMBODIMENT

The present invention relates to a RF signal alerting device and, more particularly, to a system that notifies a person remotely that his or her RF signal receiving device is receiving a RF signal. As will be appreciated by those skilled in the arts, the inventive device can be used in any RF signal receiving device, such as a cellular phone, an email device, or pager. For simplicities sake, the following description will refer to either a RF signal receiving device or cellular phone.

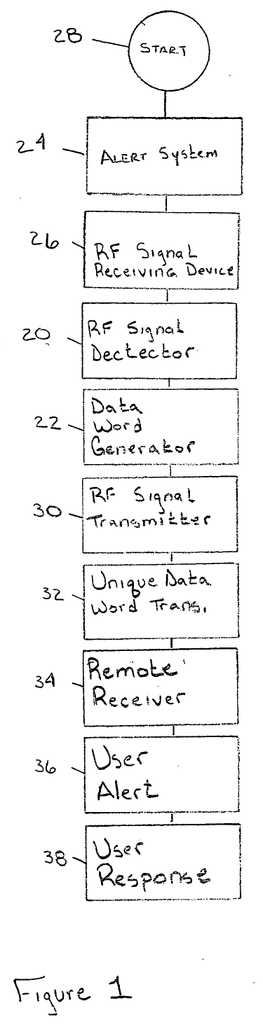

FIG. 1 is a flowchart depicting a general overview of the inventive alert system. The RF signal detector 20, data word generator 22, and unique word transmitter 30 of alert system 24 are linked to an RF signal receiving device 26. When RF signal receiving device 26 receives an RF signal 28, it activates the RF signal detector 20 of alert system 24.

RF detector 20 transmits a notification to data word generator 22 that a RF signal was received by RF signal receiving device 26. Data word generator 22 then creates a unique data word recognizable only by system receiver 34. Data word generator 22 relays the unique word 32 to system transmitter 30.

System transmitter 30 transmits the unique data word 32 to a remote alert system receiver 34. The remote alert system receiver 34 in turn emits an audio, visual, or vibratory signal 36 which alerts the RF signal receiving device user that his or her device is receiving a signal at 38.

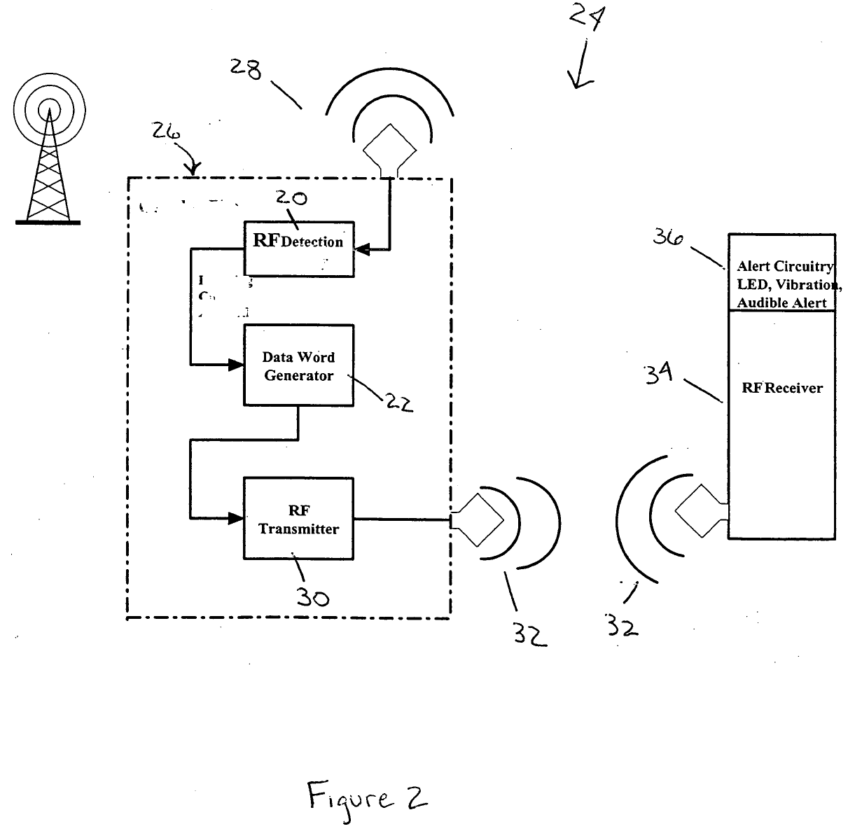

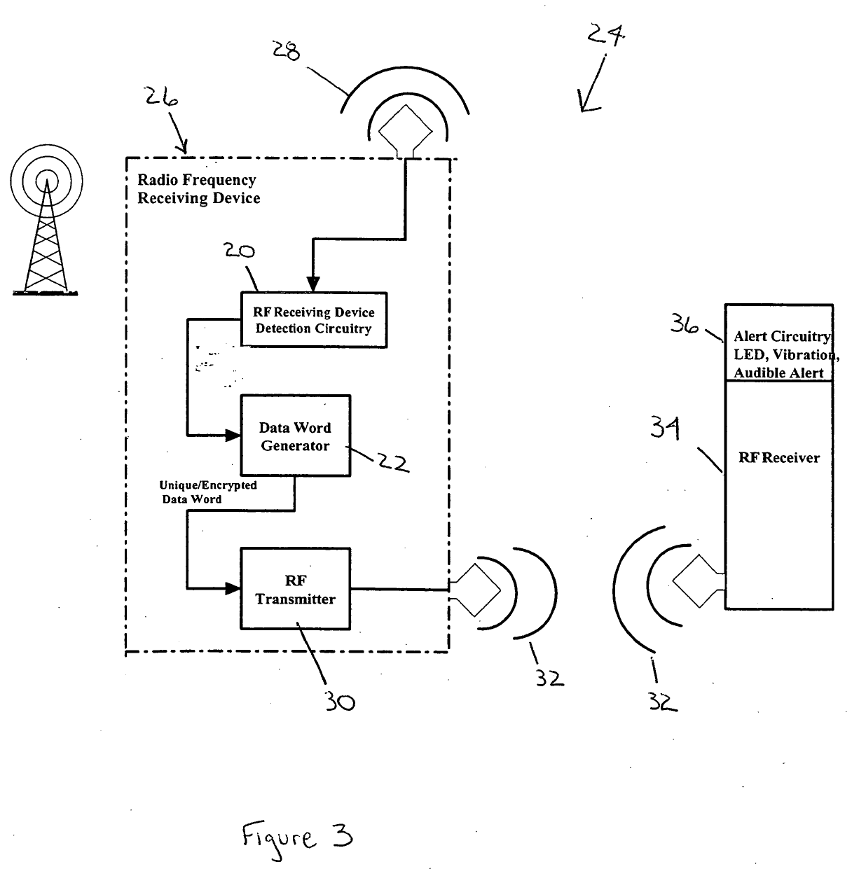

The RF signal detector 20, data word generator 22, and unique word transmitter 30 configuration is not critical. For instance, FIG. 2 depicts the instance when RF signal detector 20 is a separate detection component that is embedded into a RF receiving device along with the data word generator 22, and unique word transmitter 30. FIG. 3 depicts the instance when the RF receiving device acts as the RF signal detector 20, thereby sending notification directly to the data word generator 22, which, along with unique word transmitter 30 is embedded into the RF signal receiving device. Configurations depicted in FIGS. 2 and 3 illustrate that the RF signal detector 20, data word generator 22, and unique word transmitter 30 employ the RF signal receiving device power supply for its own power.

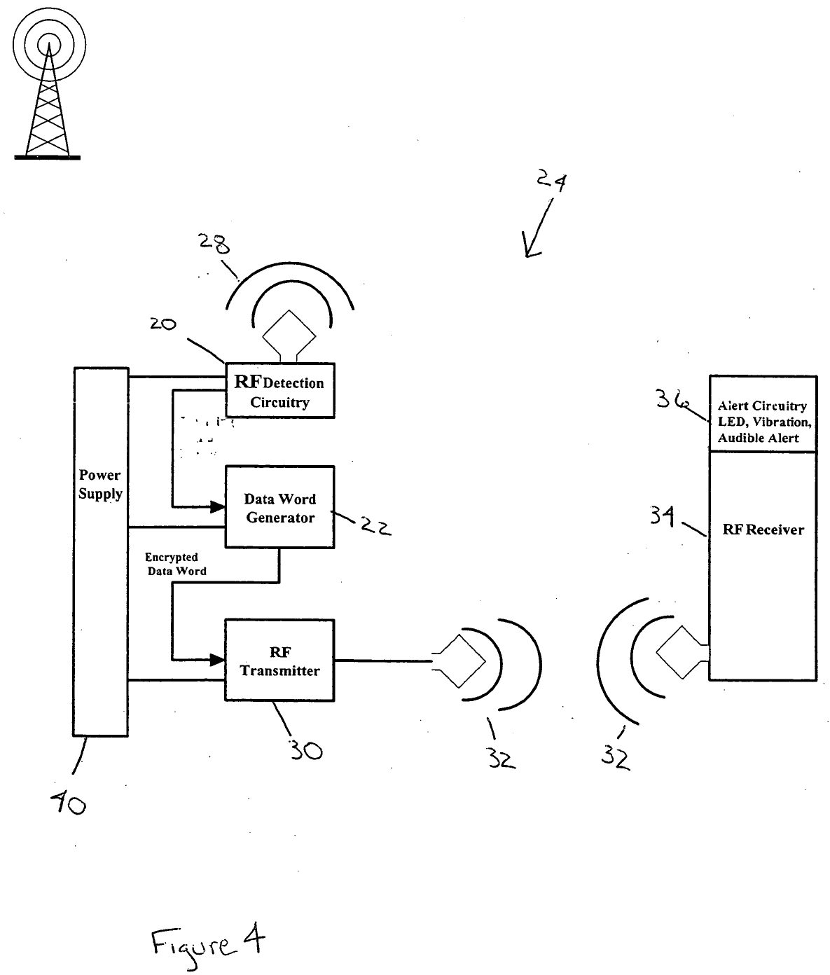

FIG. 4 depicts the instance when the RF signal detector 20, data word generator 22, and unique word transmitter 30 are externally linked to the RF signal receiving device. In this instance, the RF signal detector 20, data word generator 22, and unique word transmitter 30 are wired into the RF receiving device power supply.

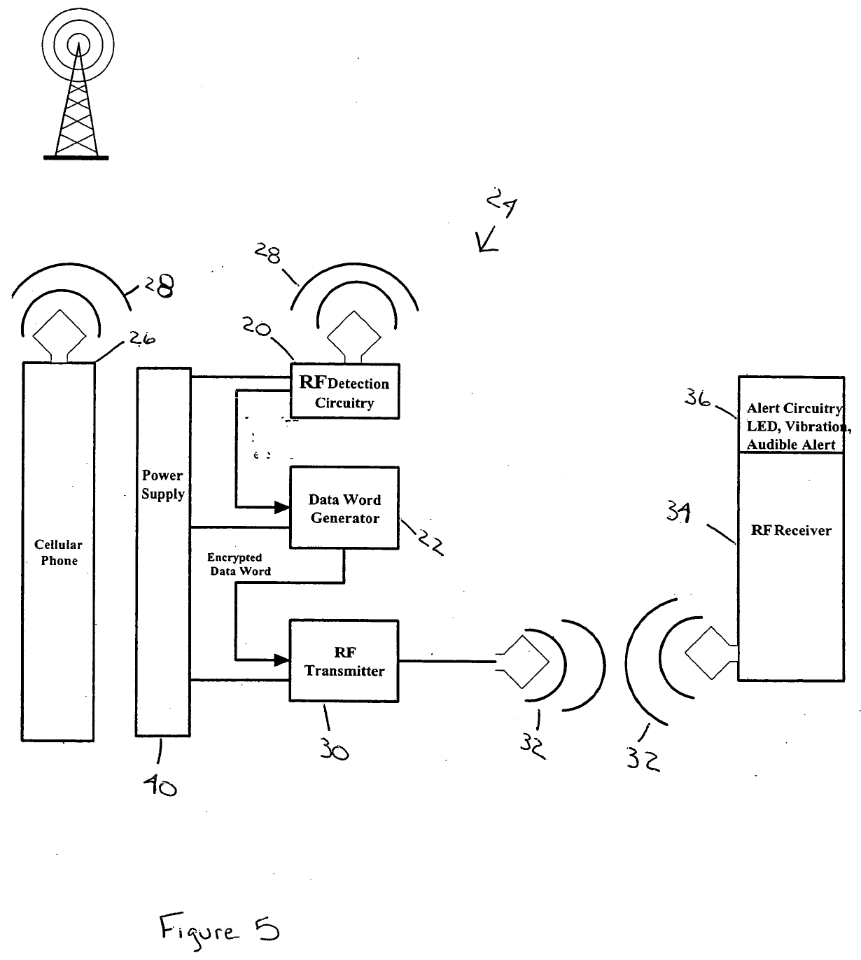

FIG. 5 depicts the instance when RF signal detector 20, data word generator 22, and unique word transmitter 30 are externally linked to RF signal receiving device 26 and employs an external power supply 40 for operation.

Regarding the RF Signal detector 20, although any circuitry that enables detection of an incoming signal can be used, the inventors prefer a 1N5711 Schottky diode type for the reason that the detection threshold voltage is adjustable and temperature can be compensated with another 1 N5711. Within detector 20, a first op-amp acts as a comparator and a second op-amp places the trigger in memory for several seconds so that the circuit does not drop out with temporary signal fades. When the circuitry becomes active as a result of an incoming cellular call (RF signal), a notifying signal is sent to the unique data word generator 22, which in turn creates a unique data word and provides it to the unique data word transmitter 30.

Regarding the unique data word generator 22, the inventors have found that a good encryption algorithm is one that uses the 28 bit transmitter serial number and the 64-bit manufacturer's code to generate the crypt key. The 16-bit synchronization counter is the basis behind the transmitted code word changing for each transmission. For purposes of the alert system 24, it increments each time a unique data word signal 32 is transmitted. As will be apparent to those skilled in the art, due to the code hopping algorithm's complexity, each increment of the synchronization value results in greater than 50% of the bits changing in the transmitted code word. Once the encoder detects an alert transmission, it reads the transmission and updates the synchronization counter. The synchronization counter and crypt key are input to the encryption algorithm and the output is 32 bits of encrypted information. This data will change with each alert transmission. The 32-bit hopping code is combined with the alert information (4 data bits) and the serial number to form the code word transmitted to the receiver. Accordingly, the risk of false alarms is dramatically reduced.

Regarding the unique data word transmitter 30, the inventors have found that a transmitter that uses a microchip Code Hopping Encoder and a SAW (Surface Acoustic Wave) resonator (a design developed by Oatley Electronics, model HCS301 KEELOQ) works well for this purpose. The HCS301 combines a 32 bit hopping code generated by a non-linear encryption algorithm with a 28 bit serial number and six status bits to create a 66 bit transmission stream. The transmitter will operate at any carrier frequency, for example frequencies in the range of 433 MHz to 5 Ghz.

The length of the transmission eliminates the possibility of duplication where multiple transmitters are used in a crowded location. The HCS301 is powered by a 12 V battery and has four inputs that allows for a use of up to 15 functions. Again, the explanation is for example purposes only; any microchip or combination of components meeting the requirements of the inventive system will work.

Regarding the unique data word receiver, it is a remote device which is carried by the user. The inventors have found that a receiver that uses a microchip PIC16C505 micro controller along that operates in conjunction with an HCS301 based transmitter works well with the described components.

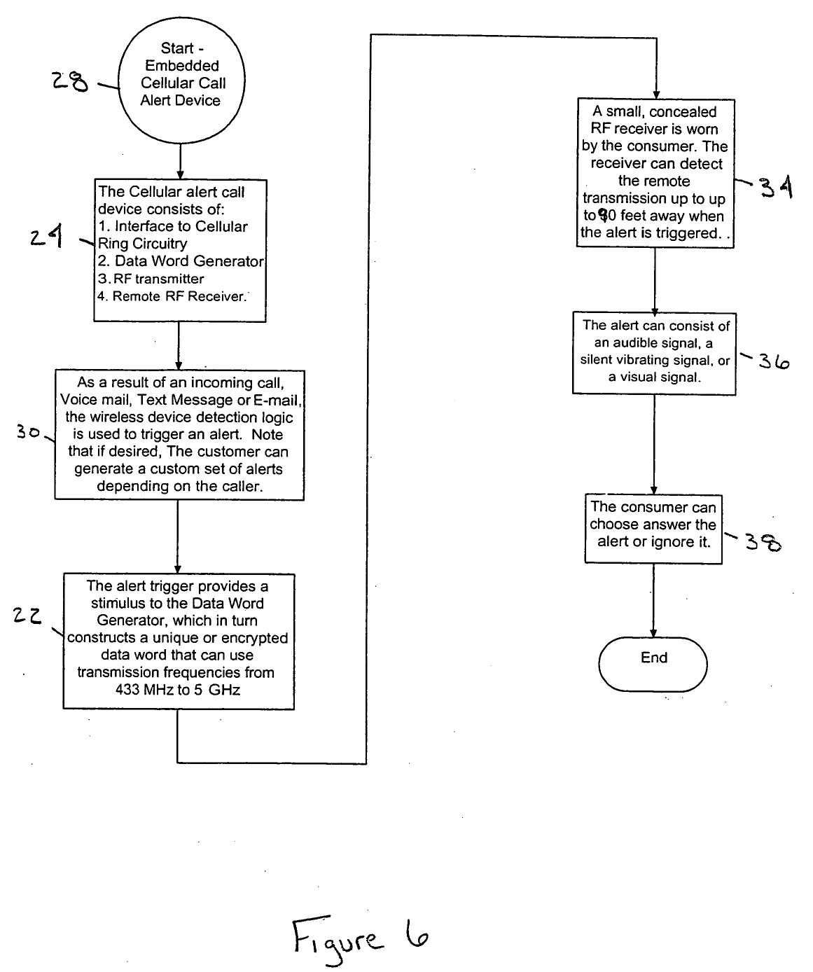

Turning to FIG. 6, a flowchart of the alert system in operation is illustrated. In this example, the alert system 20 is used by a user having a cellular phone into which the alert system is embedded. As noted above, the system is flexible and can come in many variations without changing the spirit or scope of the inventive system. For example, the system could be embedded into a receiving system by a manufacturer as depicted in FIG. 6. In this configuration, a cellular phone manufacturer could place the RF signal detector, unique data word generator, and unique data word transmitter into the body of a phone, using the phone power supply to power the system.

Alternatively, the system could be separate from the receiving device but electrically coupled to it, thereby using the power supply of the RF signal receiving device to power the alert system. Yet another possibility would be to have a free standing unit, complete with its own power supply, which is attached to the RF signal receiving device.

Once the alert system, of any configuration, is coupled to a receiving device, it is in a quiescent “training mode” 42 in which it is standing by, waiting for an incoming signal. Once an incoming signal 28 is received by the RF signal receiving device 26, the RF signal detector 20 of the alert system 24 will sense it, triggering a response. The response activates the unique data word generator 22. The unique data word generator 22 then triggers the unique data word transmitter 30 to send a unique data word code 32 which identifies an incoming signal to the particular receiving apparatus to a remote unique data word receiver 34. The unique data word receiver may use rolling code hardware/firmware to ensure that no false alarms occur as a result of other similar alert systems in the area. The unique data word receiver 34 then checks the incoming data word. If it is valid the receiver, in turn, sends a signal to an output. Depending on how the unique data word receiver circuitry is arranged, the alert can be, for example, vibratory, auditory, or visual in nature. The user can elect to answer the call or ignore the system 38.

The transmitter can be of any strength. The inventors, without limiting their invention, have described above a configuration that will notify a user of a call up to 30 meters away.

The unique data word receiver 34 is a remote unit carried by the user. The apparatus is small and worn or carried by the cellular subscriber when the subscriber's phone is located in another room, a bag, briefcase, purse etc. It can come in many forms, such as a pendent, a necklace, a bracelet, or a coin-sized piece.

It is contemplated that the RF signal detector, unique data word generator, and the unique data word transmitter will be coupled together into an integrated package for applications wherein the cellular phone is not used as the RF detector. The package may be incorporated directly into a cellular phone, or it may be packaged independently with its own power supply. Those skilled in the arts will realize that packaging is not critical and a fully functioning system will result if separate pieces are used.

When the alert system is embedded into a cell phone, any stimulus can be used as the detector and to trigger the transmitter circuitry. For an unembedded, dependent or stand alone system, the RF detector circuitry should be placed in proximity of the cellular phone such that it can detect an incoming signal to that phone.

1. A radio frequency signal notification system comprising a radio frequency signal detector, a data word generator that generates a unique data word, a radio frequency signal transmitter that accepts the unique data word from the data word generator, and a radio frequency signal receiver for receiving a transmission of the unique data word from the radio frequency transmitter.

2. The radio frequency signal notification system of claim 1 wherein the data word generator creates a data word.

3. The radio frequency signal notification system of claim 1 wherein the data word generator encrypts a data word.

4. A radio frequency signal notification system comprising a radio frequency signal detector, a data word generator that generates a unique data word, a radio frequency signal transmitter that accepts the unique data word from the data word generator, and a radio frequency signal receiver for receiving a transmission of the unique data word from the radio frequency transmitter, the radio frequency receiver further having the ability to recognize the unique code and emit an alert.

5. The radio frequency signal notification system of claim 4 wherein the data word generator creates a data word.

6. The radio frequency signal notification system of claim 4 wherein the data word generator encrypts a data word.

7. The radio frequency receiver of claim 4 wherein the alert is a vibration.

8. The radio frequency receiver of claim 4 wherein the alert is an auditory alert.

9. The radio frequency receiver of claim 4 wherein the alert is a visual alert.

10. The radio frequency signal notification system of claim 4 wherein the radio frequency signal transmitter uses a carrier frequency.

11. The radio frequency signal transmitter of claim 10 wherein the carrier frequency is in the range of 433 MHz to 5 GHz.

12. A radio frequency signal notification system comprising a radio frequency signal detector, a data word generator that generates a unique data word, a radio frequency signal transmitter that accepts the unique data word from the data word generator embedded into the circuitry of a radio frequency receiving device, and a remote frequency signal receiver for receiving a transmission of the unique data word from the radio frequency transmitter.

13. The radio frequency signal notification system of claim 12 wherein the data word generator creates a data word.

14. The radio frequency signal notification system of claim 12 wherein the data word generator encrypts a data word.

15. A radio frequency signal notification system comprising a radio frequency signal detector, a data word generator that generates a unique data word, a radio frequency signal transmitter that accepts the unique data word from the data word generator embedded into the circuitry of a radio frequency receiving device, and a remote frequency signal receiver for receiving a transmission of the unique data word from the radio frequency transmitter, the radio frequency receiver further having the ability to recognize the unique data word and emit an alert.

16. The radio frequency signal notification system of claim 15 wherein the data word generator creates a data word.

17. The radio frequency signal notification system of claim 15 wherein the data word generator encrypts a data word.

18. The radio frequency receiver of claim 15 wherein the alert is a vibration.

19. The radio frequency receiver of claim 15 wherein the alert is an auditory alert.

20. The radio frequency receiver of claim 15 wherein the alert is a visual alert.

21. The remote cellular phone call notification system of claim 15 wherein the radio frequency signal transmitter uses a carrier frequency.

22. The radio frequency signal transmitter of claim 21 wherein the carrier frequency is in the range of 433 MHz to 5 GHz.

23. A radio frequency signal notification system comprising a radio frequency signal detector, a data word generator that generates a unique data word, a radio frequency signal transmitter that accepts the unique data word from the data word generator embedded into the circuitry of a cellular phone, and a remote frequency signal receiver for receiving a transmission of the unique data word from the radio frequency transmitter, the radio frequency receiver further having the ability to recognize the unique data word and emit an alert.

24. The radio frequency signal notification system of claim 23 wherein the data word generator creates a data word.

25. The radio frequency signal notification system of claim 23 wherein the data word generator encrypts a data word.

26. The radio frequency receiver of claim 23 wherein the alert is a vibration.

27. The radio frequency receiver of claim 23 wherein the alert is an auditory alert.

28. The radio frequency receiver of claim 23 wherein the alert is a visual alert.

29. The cellular phone call notification system of claim 23 wherein the radio frequency signal transmitter uses a carrier frequency.

30. The radio frequency signal transmitter of claim 29 wherein the carrier frequency is in the range of 433 MHz to 5 GHz.

31. A radio frequency signal notification system comprising a radio frequency receiving device further comprising incoming signal detection ability thereby acting as a radio frequency detector, a data word generator that generates a unique data word, a radio frequency signal transmitter that accepts the unique data word from the data word generator, and a radio frequency signal receiver for receiving a transmission of the unique data word from the radio frequency transmitter.

32. The radio frequency signal notification system of claim 31 wherein the data word generator creates a data word.

33. The radio frequency signal notification system of claim 31 wherein the data word generator encrypts a data word.

34. A radio frequency signal notification system comprising a radio frequency receiving device further comprising incoming signal detection ability thereby acting as a radio frequency detector, a data word generator that generates a unique data word, a radio frequency signal transmitter that accepts the unique data word from the data word generator, and a radio frequency signal receiver for receiving a transmission of the unique data word from the radio frequency transmitter, the radio frequency receiver further having the ability to recognize the unique code and emit an alert.

35. The radio frequency signal notification system of claim 34 wherein the data word generator creates a data word.

36. The radio frequency signal notification system of claim 34 wherein the data word generator encrypts a data word.

37. The radio frequency receiver of claim 34 wherein the alert is a vibration.

38. The radio frequency receiver of claim 34 wherein the alert is an auditory alert.

39. The radio frequency receiver of claim 34 wherein the alert is a visual alert.

40. The radio frequency signal notification system of claim 34 wherein the radio frequency signal transmitter uses a carrier frequency.

41. The radio frequency signal transmitter of claim 40 wherein the carrier frequency is in the range of 433 MHz to 5 GHz.

42. The radio frequency detector of claim 34 further comprising a cellular phone.

43. A radio frequency signal notification system comprising a radio frequency receiving device having a power supply, a radio frequency detector, a data word generator that generates a unique data word, a radio frequency signal transmitter that accepts the unique data word from the data word generator, and a radio frequency signal receiver for receiving a transmission of the unique data word from the radio frequency transmitter, wherein the radio frequency detector utilizes the radio frequency receiving device power supply for operation.

44. The radio frequency signal notification system of claim 43 wherein the data word generator creates a data word.

45. The radio frequency signal notification system of claim 43 wherein the data word generator encrypts a data word.

46. A radio frequency signal notification system comprising a radio frequency receiving device having a power supply, a radio frequency detector, a data word generator that generates a unique data word, a radio frequency signal transmitter that accepts the unique data word from the data word generator, and a radio frequency signal receiver for receiving a transmission of the unique data word from the radio frequency transmitter, wherein the radio frequency detector utilizes the radio frequency receiving device power supply for operation, and the radio frequency receiver further having the ability to recognize the unique data word and emit an alert.

47. The radio frequency signal notification system of claim 46 wherein the data word generator creates a data word.

48. The radio frequency signal notification system of claim 46 wherein the data word generator encrypts a data word.

49. The radio frequency receiver of claim 46 wherein the alert is a vibration.

50. The radio frequency receiver of claim 46 wherein the alert is an auditory alert.

51. The radio frequency receiver of claim 46 wherein the alert is a visual alert.

52. The remote cellular phone call notification system of claim 46 wherein the radio frequency signal transmitter uses a carrier frequency.

53. The radio frequency signal transmitter of claim 52 wherein the carrier frequency is in the range of 433 MHz to 5 GHz.

54. A cellular phone signal notification system comprising a radio frequency receiving device having a power supply, a radio frequency detector, a data word generator that generates a unique data word, a radio frequency signal transmitter that accepts the unique data word from the data word generator, and a radio frequency signal receiver for receiving a transmission of the unique data word from the radio frequency transmitter, wherein the radio frequency detector utilizes the radio frequency receiving device power supply for operation, and the radio frequency receiver further having the ability to recognize the unique data word and emit an alert.

55. The radio frequency signal notification system of claim 54 wherein the data word generator creates a data word.

56. The radio frequency signal notification system of claim 54 wherein the data word generator encrypts a data word.

57. The radio frequency receiver of claim 54 wherein the alert is a vibration.

58. The radio frequency receiver of claim 54 wherein the alert is an auditory alert.

59. The radio frequency receiver of claim 54 wherein the alert is a visual alert.

60. The remote cellular phone call notification system of claim 54 wherein the radio frequency signal transmitter uses a carrier frequency.

61. The radio frequency signal transmitter of claim 60 wherein the carrier frequency is in the range of 433 MHz to 5 GHz.

62. A radio frequency signal notification system comprising a radio frequency signal detector, a data word generator that generates a unique data word, a radio frequency signal transmitter that accepts the unique data word from the data word generator, the radio frequency detector, data generator, and radio frequency transmitter further powered by a power supply, and a radio frequency signal receiver for receiving a transmission of the unique data word from the radio frequency transmitter.

63. The radio frequency receiver of claim 62 further comprising a power supply.

64. The radio frequency signal notification system of claim 62 wherein the data word generator creates a data word.

65. The radio frequency signal notification system of claim 62 wherein the data word generator encrypts a data word.

66. A radio frequency signal notification system comprising a radio frequency signal detector, a data word generator that generates a unique data word, a radio frequency signal transmitter that accepts the unique data word from the data word generator, the radio frequency detector, data generator, and radio frequency transmitter further powered by a power supply, and a radio frequency signal receiver for receiving a transmission of the unique data word from the radio frequency transmitter, the radio frequency receiver further having the ability to recognize the unique code and emit an alert.

67. The radio frequency signal notification system of claim 66 wherein the data word generator creates a data word.

68. The radio frequency signal notification system of claim 66 wherein the data word generator encrypts a data word.

69. The radio frequency receiver of claim 66 wherein the alert is a vibration.

70. The radio frequency receiver of claim 66 wherein the alert is an auditory alert.

71. The radio frequency receiver of claim 66 wherein the alert is a visual alert.

72. The remote cellular phone call notification system of claim 66 wherein the radio frequency signal transmitter uses a carrier frequency.

73. The radio frequency signal transmitter of claim 72 wherein the carrier frequency is in the range of 433 MHz to 5 GHz.

74. A cellular phone signal notification system comprising a radio frequency signal detector, a data word generator that generates a unique data word, a radio frequency signal transmitter that accepts the unique data word from the data word generator, the radio frequency detector, data generator, and radio frequency transmitter further powered by a power supply, and a radio frequency signal receiver for receiving a transmission of the unique data word from the radio frequency transmitter, the radio frequency receiver further having the ability to recognize the unique code and emit an alert.

75. The radio frequency signal notification system of claim 74 wherein the data word generator creates a data word.

76. The radio frequency signal notification system of claim 74 wherein the data word generator encrypts a data word.

77. The radio frequency receiver of claim 74 wherein the alert is a vibration.

78. The radio frequency receiver of claim 74 wherein the alert is an auditory alert.

79. The radio frequency receiver of claim 74 wherein the alert is a visual alert.

80. The remote cellular phone call notification system of claim 74 wherein the radio frequency signal transmitter uses a carrier frequency.

81. The radio frequency signal transmitter of claim 80 wherein the carrier frequency is in the range of 433 MHz to 5 GHz.

82. A method for notifying a radio frequency receiving device user of an incoming signal to a radio frequency receiving device comprising the steps of:
a. the radio frequency device detecting an incoming RF signal;
b. the RF signal being sent to a data word generator;
c. the data word generator creating a unique data word;
d. the unique data word being transmitted to a unique data word receiver by a unique data word transmitter;
e. the unique data word receiver emitting an alert signal to the radio frequency receiving device user.

83. The method of claim 82 further comprising the step of encrypting the unique data word.
